(19) United States
(12) Patent Application Publication
(10) Pub. No.: US 2024/0159226 A1
(43) Pub. Date: May 16, 2024

(54) Frameshift Generator

(71) Applicant: Douglas C. Wyatt, New York, NY (US)

(72) Inventor: Douglas C. Wyatt, New York, NY (US)

(21) Appl. No.: 18/382,529

(22) Filed: Oct. 22, 2023

Related U.S. Application Data
(60) Provisional application No. 63/418,510, filed on Oct. 22, 2022.

(51) Int. Cl. F03G 7/10

(52) U.S. Cl. CPC F03G 7/119

(57) ABSTRACT

An apparatus is provided which utilizes a plurality of heavy spinning masses in a coplanar and coaxial orientation which when utilized together magnify and reinforce frame dragging effect and create a frameshift.

### PRIORITY

This application claims priority to the U.S. Provisional Application Ser. No. 63/418,510 having a filing date of Oct. 22, 2022, the entire contents of which are all relied upon and fully incorporated herein by reference.

### FIELD OF THE INVENTION

The field of the invention relates to astrophysics, and gravitation, more particularly nonlinear gravitodynamics. More specifically, the present invention relates to the design of a frameshift generator apparatus which utilizes a plurality of heavy spinning masses which when utilized together magnify and reinforce frame dragging effect.

### BACKGROUND OF THE INVENTION

In 2011, results of the Gravity Probe B experiment were published describing a unique experiment to test and confirm predictions of Einstein's theory that space and time are not the immutable rigid structures of the Newton's universe but are united as space-time, and together they are malleable, and workable. A background and understanding of nonlinear Gravitodynamics and Lense-Thirring theory is useful here.

It is to be understood that both the foregoing and the following descriptions are exemplary and explanatory only and are not restrictive of the invention, as claimed. Specific examples are included in the following description for clarity, but various details can be changed within the scope of the present invention.

### SUMMARY OF THE INVENTION

An apparatus is provided which utilizes a plurality of heavy spinning masses which when utilized together magnify and reinforce frame dragging effect. Previously, experimental devices, such as in the Gravity Probe B, measured frame dragging effect of slowly rotating heavy masses, such as the earth, and when measured over a long period of time produced a frame dragging effect that was measurable by the sensitive instruments of the gravity probe B experiment. While conventional gyroscopes having singular rotational apparatuses have measured the minute changes of the local frame of the experimental apparatus, heretofore no devices or experimental apparatuses have utilized the frame dragging effect in their local frames because of limitations of material tolerances prevent use of conventional gyroscope or spinning objects to the extreme and angular velocities required to produce significant usable effects. The instant invention overcomes the limitations of material tolerances by producing a local frame dragging effect within the material whereby the stresses are abated within the local frame.

At times described herein, one or more “frames” are referred to, and it is understood by a person of ordinary skill in the art in the field of the invention that such frames are understood as frames of space-time, and wherein mass and energy existing in these frames of space-time define relativistic effects with respect to other frames dependent upon effective masses and rates of relative velocity. In particular “substantial rates” of spin wherein relativistic effects can be perceived within a reasonable timeframe according to the desired scale and use by the reader of this disclosure of a device according to the invention. While various embodiments are possible to be within the scope of the invention, a preferred embodiment is provided herein having a particular range of “effective mass” and “substantial rate” to make a device according to the invention for use with experimentation of frameshift generation properties of the instant invention.

For example, a preferred subject mass can be provided with “effective mass” by being fabricated as a disk from the dense metal and homogenous to at least one part in 10\hat{ }6. The material chosen should be sufficient to sustain substantial angular velocity and resist the strain associated with forces when accelerated spin over 1000 cm/s. Titanium is a viable choice of material, but other dense metals can be used if fabricated properly. In one further embodiment, niobium is included, and will be addressed later. By further example, “substantial rate” is a rate much greater than conventional gyroscopes by factor of 100-1,000. The requirements of instant invention are significantly different than requirements of gyroscopes which are typically used as measurement instruments, and value accuracy and precision. For example, the gravity probe B required tolerances of the sphere to the machined to be spherical and homogenous to tolerance of better than one part per million to satisfy accuracy of measurement. While desirable, such tolerances are not necessary provided the chosen material can sustain the forces while the apparatus according to the invention is permitted to “spin up” and shift the frame of the materials undergoing the extreme stresses.

### BRIEF DESCRIPTION OF THE DRAWINGS

A preferred embodiment of the invention has been chosen for detailed description to enable those having ordinary skill in the art to which the invention pertains to understand how to construct and use the invention readily and is shown in the accompanying drawings in which:

FIG. 1 is a conceptual diagram of a top view of a portion of an embodiment of frame shift generator according to the invention showing the subject mass and plurality of rotational masses.

FIG. 2 is a conceptual diagram of a portion of an embodiment of a frameshift generator according to the invention from a side perspective view.

FIG. 3 is a conceptual diagram of a portion of an embodiment of a frameshift generator according to the invention from a side perspective view with a portion cutaway.

FIG. 4 is a conceptual diagram of a portion of an embodiment of a frameshift generator according to the invention from a side cross-section view.

FIG. 5 is a conceptual diagram of a portion of an embodiment of a frameshift generator according to the invention from a side top view showing housing and housing ports.

FIG. 6 is a conceptual diagram of a portion of an embodiment of a frameshift generator according to the invention from a side view showing primary and secondary movers.

FIG. 7 is a conceptual diagram of an embodiment of an embodiment of a support system for an embodiment of a frameshift generator according to the invention from a top view showing subsystems.

FIG. 8 is a conceptual diagram generation of frame shifting effects produced by an embodiment of an embodiment of a of a frameshift generator according to the invention from a top view.

The above-referenced figures are not to scale and are for reference only to assist the reader in understanding the invention in conjunction with the detailed written description which follows.

### DETAILED DESCRIPTION OF THE INVENTION

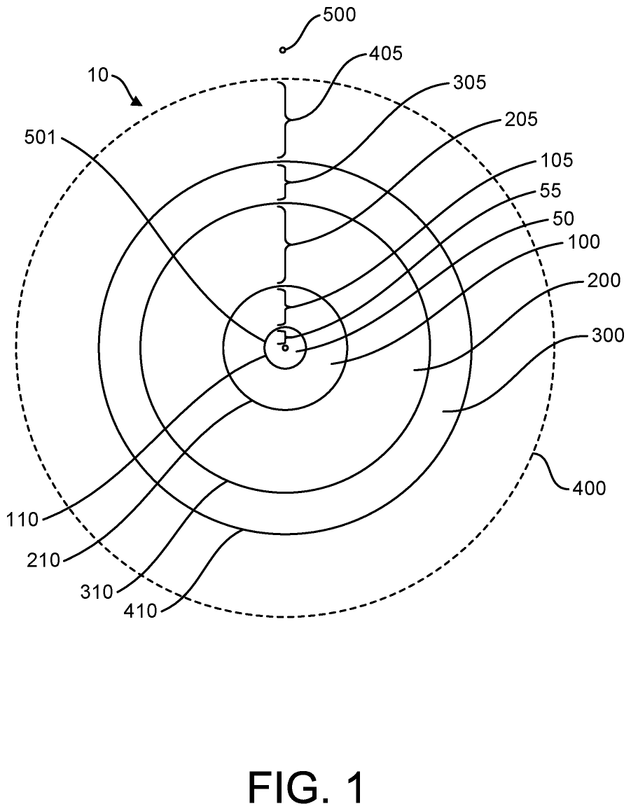

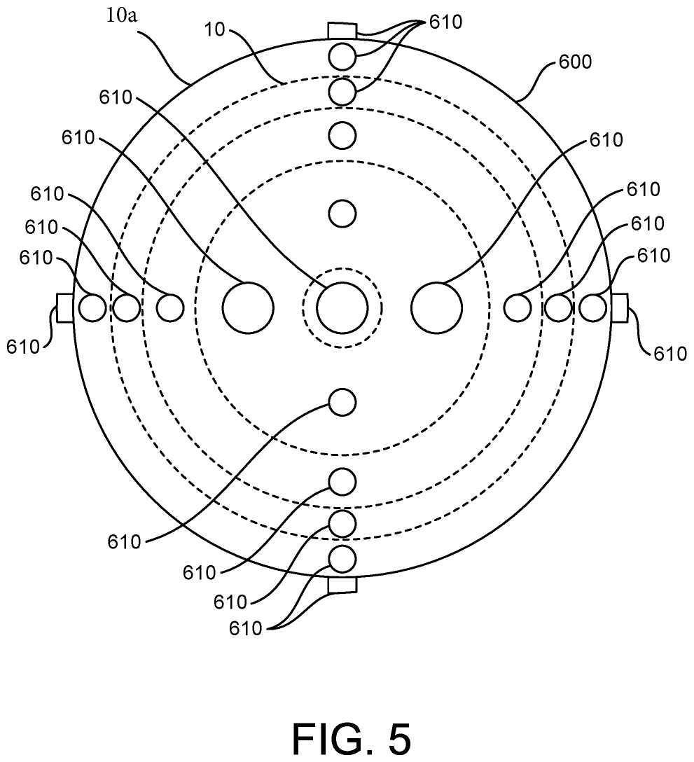

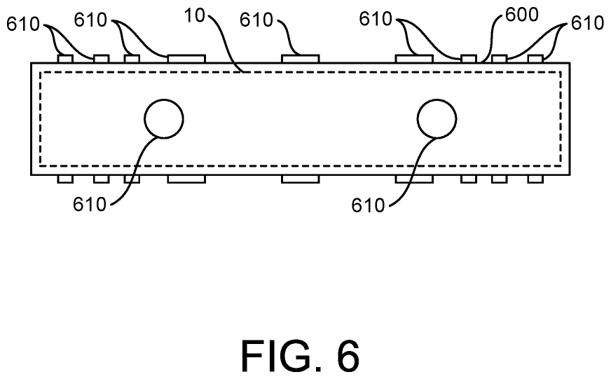

FIG. 1 shows an embodiment of frame shift generator 10 according to the invention. The embodiment shown in FIG. 1 includes a subject mass 50, a center axis 501, and a plurality of rotational masses 100, 200, 300 which collectively are represented as 10a in FIG. 1 for purposes of clarity and introduction. The frameshift generator 10 can also include a housing 600, a prime mover 620, and at least one secondary mover 630, as shown in FIGS. 5 and 6 and described further below.

The subject mass 50 is disposed in a first reference frame 801 at the center axis 501 within the apparatus having an “effective” mass and adapted to be subject to a “substantial rate” of spin. “Effective mass” and “substantial rate” of spin are described further herein. The subject mass 50, for example, can be fabricated from titanium as disk of 10 cm radius×4 cm, (subject radius 55) and preferably homogenous within one part 10\hat{ }6. The subject mass 50 is the first driver of the frameshift generator and produces a small “frame dragging” effect, or first induced frame drag 802, upon reaching its a predetermined maximum rotational velocity for a particular design tolerance when spun up by the prime mover 620, described further below in FIGS. 5 and 6.

An embodiment of the frameshift generator 10 also includes a plurality of rotational masses 100, 200, 300. In one embodiment, a first rotational mass 100 is provided having a first substantial mass, (and first added radius 105) and in a preferred embodiment is provided as a ring fabricated from dense homogenous material such as titanium. Again, considerations of choice of material are similar to that of the subject mass 50. The first rotational mass 100 is uniformly distributed as a homogenous ring around the subject mass and in immediate proximity to the outer edge of the disk of the subject mass 50, separated by at least a first spacing 110. In one embodiment, the first rotational mass is provided as a ring with inner diameter of a little more than 5 cm (depending on choice of first spacing 110) and an outer diameter of 8 cm (first added radius 105) and having a width matching the chosen width of the subject mass 50 and coaxial with the subject mass center axis 501. (Thus, adding to the effective radius of the rotational generator). In one embodiment, a vacuum is provided in the first spacing 110, however in alternative embodiments, the first spacing 110 can include cryo-materials such as liquid helium. The size of the first spacing 110 between the first rotational mass 100 and the second rotational mass 200 is preferably as small as tolerances will allow depending on whether the housing 600 is filled with liquid helium or other cryo-material 705 (as additional spacing will delay the “spin up”). For example, in an alternative embodiment, the first rotational mass 100 can be coated with a thin layer of niobium and supercooled to take advantage of the effect of London moment to help “spin up” the first rotational mass without requiring a secondary mover 630.

An embodiment of the frameshift generator includes a second rotational mass 200 and shares the same fabrication considerations to that of the first rotational mass 100. The second rotational mass has a second substantial mass and is uniformly distributed in a ring around and proximate to the first rotational mass. For example, in one embodiment, a second rotational mass 200 is provided as a titanium ring having an inner diameter of a little more than 8 cm (depending on choice of second spacing 210) and an outer diameter of approximately 10 cm. The second rotational mass is coplanar with both the first rotational mass and the subject mass, and likewise is coaxial with the center axis and axis of rotation of the first rotational mass. The second rotational mass is provided in close proximity to the first rotational mass and separated by a second spacing 210, which again is preferably as close as tolerances will allow.

As shown in FIG. 1, a further embodiment of a frameshift generator 10 according to the invention can include a third rotational mass 300, provided as a homogenous ring with an effective mass, and separated from the second rotational mass 200 by a third spacing 310. Again the third rotational mass 300 is coplanar and coaxial with the first and second rotational masses, and shares the same fabrication considerations. In one embodiment, the third rotational mass has an added effective radius 405, and can be designed as a titanium ring with inner diameter of little more than 10 cm and outer diameter of 12 cm. The dimensions of the plurality of rotational masses preferably match the thickness (h) of the subject mass 50.

Also shown in FIG. 1 is a frame perimeter 410 which defines the outer edge of the effective moving frames of the frameshift generator 10, a measured frame distance 405 and reference measurement point 500 which are provided for reference which are described further below, and help explain how the frameshift generator 10 can be used in different circumstances.

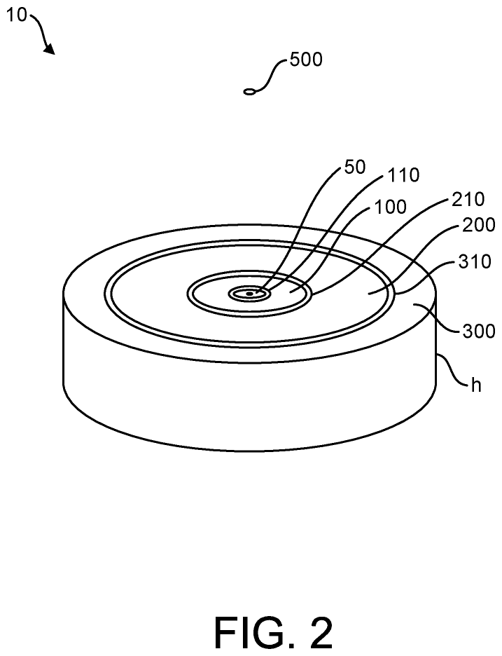

FIG. 2 shows a portion 10a of an embodiment of a frameshift generator 10 according to the invention from a side perspective view. In addition to the structures described above with respect to FIG. 1, FIG. 2 shows a plurality of control signal devices 510 disposed on a top surface of the subject mass 50, and top surface of each of the plurality of the rotational masses 100, 200, 300. The control signal device 510 is preferably provided as a reflective surface for receiving and reflecting a signal from at least one sensor 520 associated with sensor control system 520, associated with the Gyro control subsystem 730 described further herein. The control signal device 510 provides feedback to the control subsystem 730 for measuring the effective rate of frame drag due to the inertia of the frame dragging effect, and allows the system to measure the rate of increase of angular velocity of the system, and allow the system to “spin up” to prevent damage to the device when operated up to the limits of material tolerances.

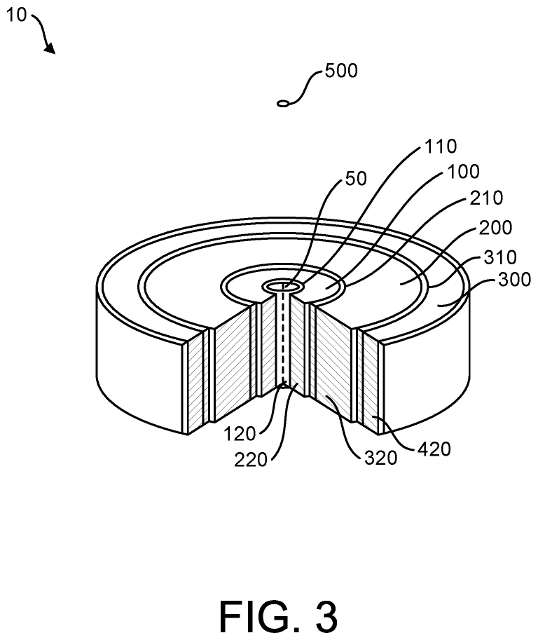

FIG. 3 is a shows a portion 10a of an embodiment of a frameshift generator 10 according to the invention from a side perspective view with a portion cutaway, such as shown in FIGS. 1 and 2. In addition, FIG. 3 shows a reference measure point 500 which is a theoretical point in a frame along the axis 501 of rotation of the device, and outside of the effective frameshift generator. Effective masses outside of the frame, such as may exist at reference point 500 can dampen the spin up of device and accordingly, gravitomagnetic shielding can be provided, such as lead (not shown), to prevent dampening of the frame dragging effect that the apparatus according to the invention is intended to provide. Such shielding is outside the specific focus of the invention even though it may provide substantial benefit.

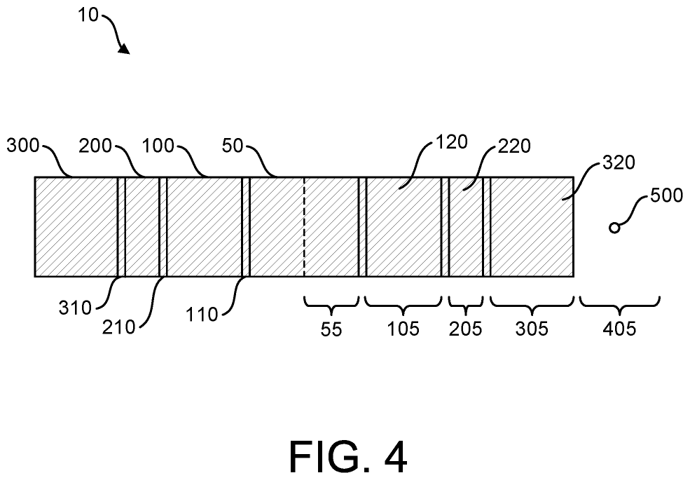

FIG. 4 is a conceptual diagram of a portion 10a of an embodiment of a frameshift generator 10 according to the invention from a side cross-section view.

As shown in FIG. 4, the subject mass and the plurality of rotational masses are disposed within the housing,
wherein the subject mass is operatively connected to the prime mover to spin around the center axis in a primary rotational direction at a first substantial rate,
and wherein the plurality of rotational masses are operatively connected to at least one secondary mover to spin around the center axis in the primary rotational direction at a secondary substantial rate, whereby upon activation of the primary mover causing the subject mass to spin at a substantial rate, the subject mass produces a first induced frame drag upon at least the first rotational mass, and whereby upon activation of the at least one secondary mover causing at least one of the plurality of rotational masses to spin, and thereby at least one of the plurality of rotational masses produces a first additive frameshift upon the subject mass.

FIG. 5 is a conceptual diagram of a portion of an embodiment of a frameshift generator 10a according to the invention from a side top view showing a housing 600 having a plurality of housing ports 610. The housing 600 is a conventional container adapted for containing the portion of the frameshift generator 10 as has shown in FIGS. 1, 2, 3 and 4. The housing 600 is preferably adapted to maintain a vacuum within to permit the subject mass 50, and plurality of rotational masses 100, 200, 300 to spin freely. In one embodiment, the housing can be fabricated from stainless steel or titanium and can include a shielding surface, such as lead. An alternative embodiment, the housing 600 can be designed as a dewar adapted to receive cryo-materials 520, such as liquid helium. A plurality of housing ports 610 are provided as apertures through the housing 600 in order to access the portion of the frame shift generator 10 contained within. Among other things, the housing ports 610 can provide ports for distribution of cryo-material 705 when operatively connected to cryo-subsystem 710. In addition, the housing ports 610 can include control system signal generators 520 for sending signals to measure the rate of spin up of the subject mass and plurality of rotational masses. In addition, the housing ports 610 can include other sensor devices such as magnetometers, and gravitometers, to measure the performance of the device.

FIG. 6 is a conceptual diagram of a portion of an embodiment of a frameshift generator 10 according to the invention from a side view showing primary mover 620 and secondary movers 630. It can be appreciated by a person of ordinary skill in the art that the primary mover 620 can be one of many conventional means for spinning up conventional gyroscopes. For example, a conventional electric engine with the flywheel such as shown in US 2020/10140102 can be utilized. However, the primary mover 620 is adapted for use with higher tolerances of the instant invention, and should be capable of inducing 3 to 4 orders of magnitude additional angular velocity and commensurate torque to be imparted on the subject mass 50. Preferably the prime mover 620 remains outside of the vacuum chamber of the housing 600 and is electro-magnetically connected to transmit torque to the subject mass 50, and once the desired rate of spin is achieved the electromagnetic system transmitting power from the primer to the subject mass 50 is disengaged.

Similarly, it can be appreciated by a person of ordinary skill in the art that the secondary movers can be a plurality of conventional electromagnetic devices which drive one or more of the plurality of rotational masses when magnetically coupled. For example, as used in linear magnetically induced transport systems, a plurality of electromagnets can be arranged around in a ring through one or more ports 610 and provide a push-pull to each rotational mass 100, 200, 300 when activated in rotational succession. Furthermore, in one embodiment of the invention where each rotational mass is coated with a thin layer of niobium and supercooled, the London moment provides an initial push to start the spin up of the rotational mass.

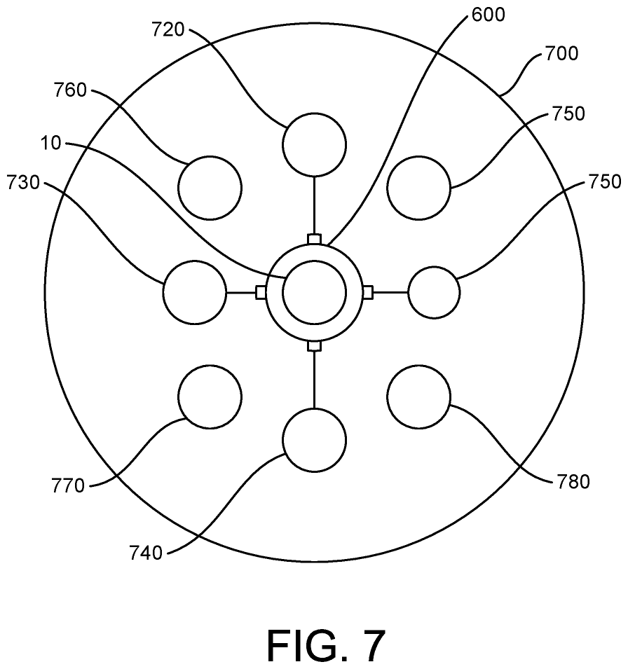

FIG. 7 is a conceptual diagram of an embodiment of an embodiment of a support system 700 for an embodiment of a frameshift generator 10 according to the invention from a top view showing several subsystems. A cryo-subsystem 710 having cryo-material 705 is provided in one embodiment of the invention where the embodiment of the rotational masses include niobium coating. In addition or in the alternative the subsystem 710 can include a vacuum system for maintaining a vacuum within the housing 600. A gyro-control subsystem 730 is provided and operatively connected to the prime mover and secondary mover for moderating the angular velocity of the subject mass and plurality of rotational masses. A Gyro anomaly correction subsystem 740 is provided to correct for and/or prevent damage to the device if one or more sensors detects anomalies or dangerous vibration. An internal communication system 750 is provided for communicating information among the various control systems. Relativistic tracking subsystem 760 is provided and operably connected to the Gyro control subsystem 730 to provide control information to the Gyro control subsystem 730 based on predetermined spin up timing measurements. A power maintenance subsystem 770 can also be provided, as well as an interface for external systems 780 such as may be required if the device is to be operated within a satellite or spacecraft.

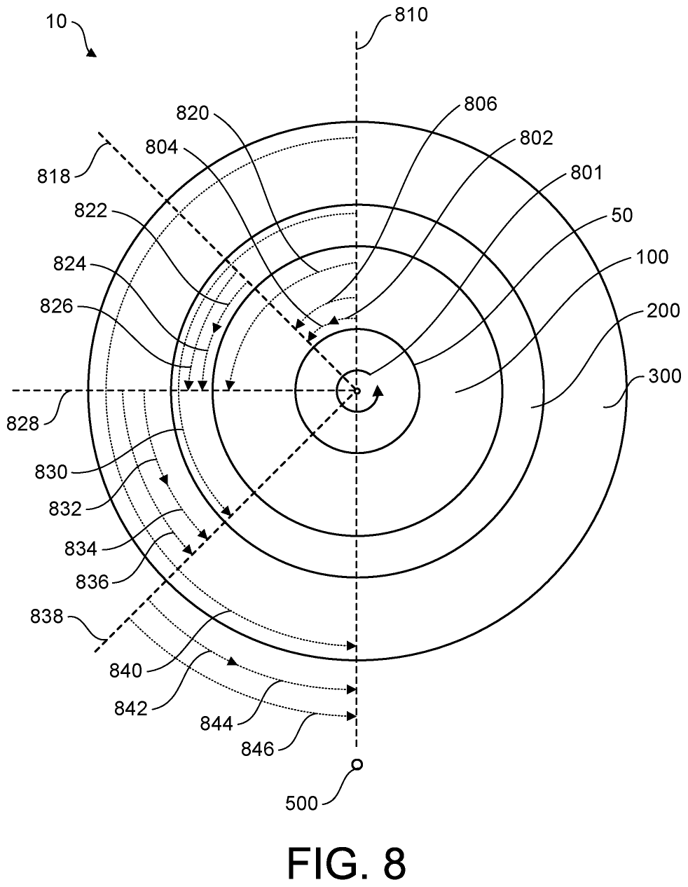

FIG. 8 is a conceptual diagram of the generation of frame shifting effects produced by an embodiment of an embodiment of a of a frameshift generator according to the invention from a top view.

In a preferred embodiment of the invention, the subject mass 50 has an effective mass and density whereby upon achieving a substantial rate of spin on the subject mass 50, a first induced frame drag is induced as upon frames external to the subject mass 50 spatial existence, namely the first rotational mass.

FIG. 8 illustrates the frame dragging aspects of the device. A first reference frame 801 is shown defining the frame of the subject mass 50. Upon spin up, a first induced frame drag 802 is produced by the spinning of the subject mass 50 and induces a drag which pulls along the second reference frame 820 associated with the first rotational mass 100. After a period of time, after spin up of the subject mass 50 to its maximum operational angular velocity, a first additive frameshift 804 is experienced by the first and second frame. Together the first induced frame drag 802 and first additive frameshift 804 produces a first frame transformation 806.

As the first rotational mass continues to spin up to its operational velocity, a second induced frame drag 820 is produced. Furthermore the subject mass 50 and first rotational mass produces a second additive frameshift. Together, the second induced frame drag a 22 and second additive frameshift 824 produce a second frame transformation 826.

Similarly as the second rotational mass spins up to its operational angular velocity, it produces a third induced frame drag upon the third reference frame wherein a third induced frame drag 832 is induced and the subject mass 50, first rotational mass, and second rotational mass induce a third additive frameshift. 834 which together produces a third frame shift transformation 836.

Where a range of values is provided, every intervening value between the upper and lower limit of that range and any other stated or intervening value in that stated range is included within the invention. The upper and lower limits of these smaller ranges may be included in the smaller ranges and are likewise included within the invention. Where the stated range includes one or both of the limits, ranges excluding either or both of those included limits are also included in the invention.

In the specification and in the appended claims, the singular forms “a,” “and,” “said,” and “the” include plural referents unless the context clearly dictates otherwise. The claims may be so drafted to require singular elements or exclude any optional element. These statements provide an antecedent basis for the use of such exclusive terminology as “solely,” “only,” and the like in connection with the recitation of claim elements and/or the use of “negative” claim limitations.

While this invention has been described in conjunction with the exemplary embodiments outlined above, the foregoing description of exemplary embodiments of the invention is illustrative, not limiting. The invention is not necessarily so constrained. Many alternatives, adaptations, modifications, and or variations may be apparent to those skilled in the art in view of the teachings provided herein.

1. A frameshift generator, comprising:
a subject mass, a center axis, a plurality of rotational masses, a housing, a prime mover, and at least one secondary mover,
wherein subject mass is disposed at the center axis, wherein the plurality of rotational masses include at least a first rotational mass and a second rotational mass, wherein the first rotational mass has a first substantial mass and is uniformly distributed in a ring around and proximate to the subject mass,
wherein the first rotational mass is coaxial with the
center axis,
wherein the second rotational mass has second substantial mass and is uniformly distributed in a ring around and proximate to the first rotational mass wherein the second rotational mass is coplanar with both the first rotational mass and the subject mass, wherein the second rotational mass and is coaxial with the center axis, wherein the subject mass and the plurality of rotational masses are disposed within the housing,
wherein the subject mass is operatively connected to the prime mover to spin around the center axis in a primary rotational direction at a first substantial rate,
and wherein the plurality of rotational masses are operatively connected to at least one secondary mover to spin around the center axis in the primary rotational direction at a secondary substantial rate,
whereby upon activation of the primary mover causing the subject mass to spin at a substantial rate, the subject mass produces a first induced frame drag upon at least the first rotational mass, and whereby upon activation of the at least one secondary mover causing at least one of the plurality of rotational masses to spin, the at least one plurality of rotational masses produces a first additive frameshift upon the subject mass.

2. A frameshift generator, comprising:
a subject mass 50, and a plurality of rotational masses 100, 200, 300,
wherein the subject mass has a center axis 501 and a first reference frame 801,
wherein the plurality of rotational masses includes at least a first rotational mass 100 having a second reference frame 820 and a second rotational 200 mass having a third reference frame 830,
wherein the first rotational mass is distributed in a ring around and proximate to the subject mass, and is coaxial with the center axis,
wherein the second rotational mass is distributed in a ring around and proximate to the first rotational mass, and wherein the second rotational mass is coplanar with both the first rotational mass and the subject mass, wherein the second rotational mass is coaxial with the center axis,
and wherein the subject mass is adapted for rotation in a first rotational direction around the central axis at a substantial rate, wherein the first rotational mass is adapted for rotation in the first rotational direction around the central axis at a substantial rate, and wherein the second rotational mass is adapted for rotation in the first rotational direction around the central axis at a substantial rate,
whereby, upon acceleration of the second rotational mass up to said substantial rate, a frame shift is produced.

3. A frameshift generator according to claim 2, further comprising a housing 600, a prime mover 620, and at least one secondary mover 630,
wherein the subject mass and the plurality of rotational masses are disposed within the housing,
wherein the subject mass is operatively connected to the prime mover to spin around the center axis in the first rotational direction at a first substantial rate, and wherein the plurality of rotational masses are operatively connected to at least one secondary mover to spin around the center axis in the primary rotational direction at a secondary substantial rate, whereby upon activation of the primary mover, the primary mover induces the subject mass to spin up to a at least a substantial rate, whereby the subject mass produces a first induced frame drag upon at least the first rotational mass, and whereby upon activation of the at least one secondary mover, the at least one secondary mover induces the first rotational mass to spin up to at least a substantial rate, whereby the first rotational mass induces a first additive frameshift upon the reference frame of subject mass.

4. A frameshift generator according to claim 1, further comprising a first spacing wherein the first spacing is disposed between the subject mass and first rotational mass and around a circumference of the subject mass, and wherein the spacing comprises at least one of the group consisting of a vacuum and a cryomaterial.

5. A frameshift generator according to claim 1, wherein said subject mass comprises a uniformly distributed material, selected from the group of consisting of homogenous titanium, and homogenous niobium.

6. A frameshift generator according to claim 1, wherein said plurality of rotational masses comprise uniformly distributed material, selected from the group of materials consisting of homogenous titanium, and homogenous niobium.

7. A frameshift generator according to claim 1, further comprising a third rotational mass wherein the third rotational mass is distributed in a ring around and proximate to the second rotational mass, and is coaxial with the center axis, and wherein is the third rotational mass adapted for rotation in a first rotational direction around the central axis at a substantial rate.

8. A frameshift generator according to claim 1, further comprising at least one additional rotational mass wherein each one of said additional rotational mass is distributed in a ring around and proximate to at least one of the plurality of rotational masses, and is coaxial with the center axis, and wherein each one of said additional rotational masses is adapted for rotation in a first rotational direction around the central axis at a substantial rate.

9. A frameshift generator according to claim 1, wherein at least one of said rotational masses further comprises a superconductive coating.

10. A frameshift generator according to claim 1, wherein at least one of said rotational masses further comprises a superconductive ring.

11. A frameshift generator according to claim 3, further comprising a first support system wherein said first support system comprises at least one components selected from the group consisting of a cryo-subsystem 700, a Gyro subsystem 720, an anomaly call correction subsystem 740, and a relativistic tracking subsystem 760.

12. A method of generating a frameshift, including the steps of providing a subject mass and a plurality of rotational masses,
inducing a subject mass to rotate on a center axis, in a first direction,
accelerating the subject mass to an operational angular velocity,
inducing a first frame drag upon a first rotational mass whereby a second reference frame is shifted,
inducing a first rotational mass to rotate on a center axis in a first direction,
accelerating the first rotational mass to an operational angular velocity,
inducing a second rotational mass to rotate on an axis in a first direction,
accelerating the second rotational mass to an operational angular velocity,
thereby inducing a first additive frameshift to a first reference frame, and thereby providing a first frame transformation.

13. A method according to claim 12, further comprising the steps of accelerating the subject mass to a further operational angular velocity.

14. A method according to claim 12, further comprising the steps of accelerating the first rotational mass to a further operational angular velocity.

15. A method according to claim 12, further comprising the steps of accelerating the second rotational mass to a further operational angular velocity.

16. A method according to claim 12, further comprising the steps of providing a superconductive coating on at least one of said plurality of rotational masses, and accelerating at least of one of said plurality of rotational masses to an operational angular velocity.

17. A method according to claim 12, wherein the operational angular velocity is a substantial rate.
